(19) United States
(12) Patent Application Publication
(10) Pub. No.: US 2023/0182049 A1
(43) Pub. Date: Jun. 15, 2023

(54) LIQUID FILTER UNIT WITH LATERALLY ARRANGED FILTERS, AND METHOD OF OPERATING THEREOF

(71) Applicant: ENTEGRIS, INC., Billerica, MA (US)

(72) Inventors: Siddarth Sampath, Tyngsboro, MA (US); Christopher Paul Barck, Westford, MA (US); Ashutosh Shrikant Bhabhe, Zug (CH); Hayden Lincicome, Waltham, MA (US)

(21) Appl. No.: 18/077,058

(22) Filed: Dec. 7, 2022

Related U.S. Application Data
(60) Provisional application No. 63/289,479, filed on Dec. 14, 2021.

(51) Int. Cl. B01D 35/30

(52) U.S. Cl. CPC B01D 35/30; B01D 2201/325

(57) ABSTRACT

A filter unit includes a housing, a first filter and a second filter disposed in the housing, and a liquid flow path that extends through the first and second filters in series. The first filter includes a first axial end affixed to the housing and a first filter media. The second filter includes a first axial end affixed to the housing at the outlet and a second filter media. The liquid directed radially outward through the first filter media and radially inward through the second filter media. A method of filtering a liquid within a filter unit includes passing the liquid radially outward through a first filter media of a first filter, directing the liquid from the first filter to a second filter, and passing the liquid radially inward through a second filter element of the second filter.

### FIELD

This disclosure generally relates to a filter unit. More particularly, this disclosure relates to filter units configured to filter a liquid.

### BACKGROUND

Filters can be employed in semiconductor manufacturing to remove contaminants from a fluid. A fluid (e.g., liquid, water, or the like) is directed through a filter unit. The filter unit can be configured to remove contaminants from the liquid as the liquid passes through the filter. Contaminants can include, for example, solid particles, liquid impurities, and dissolved chemical species.

### SUMMARY

In an embodiment, a filter unit for filtering liquid includes a housing having an inlet and an outlet, a first filter disposed in the housing, a second filter disposed in the housing, and a liquid flow path. The first filter includes a first axial end affixed to an inner surface of the housing, an axial inlet disposed over an opening of the inlet of the housing, and a first filter media. The second filter includes a first axial end affixed to the inner surface of the housing, an axial outlet disposed over an opening of the outlet in the housing, and a second filter media. The liquid flow path extends from the inlet to the outlet through the first filter media and the second filter media in series. The liquid in the liquid flow path flowing radially outward through the first filter media and radially inward through the second filter media.

In an embodiment, a method is directed to filtering a liquid within a filter unit. The filter unit includes a housing with an inlet and an outlet. The method includes directing the liquid from the inlet of the housing to a filter media of a first filter disposed in the housing. The first filter includes a first axial end affixed to an inner surface of the housing and an axial inlet disposed over an opening of the inlet of the housing. The method also includes passing the liquid radially outward through the first filter media and directing the liquid from the first filter media to a second filter media of a second filter disposed in the housing. The second filter includes a first axial end affixed to the inner surface of the housing and an axial outlet disposed over an opening of the outlet in the housing. The method also includes passing the liquid radially inward through the second filter media.

### DRAWINGS

FIG. 1 is a side perspective view of an embodiment of a filter unit.

FIG. 2 is a cross-sectional view of the filter unit in FIG. 1, according to an embodiment.

FIG. 3 is a perspective view of the cross-section of the filter unit of FIG. 2, according to an embodiment.

FIG. 4 is a block flow diagram of an embodiment of a method of filtering a liquid in a filter unit.

Like numbers represent like features.

### DETAILED DESCRIPTION

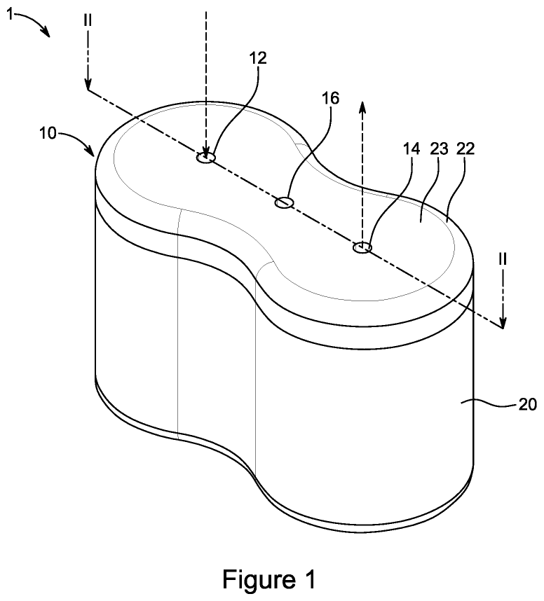

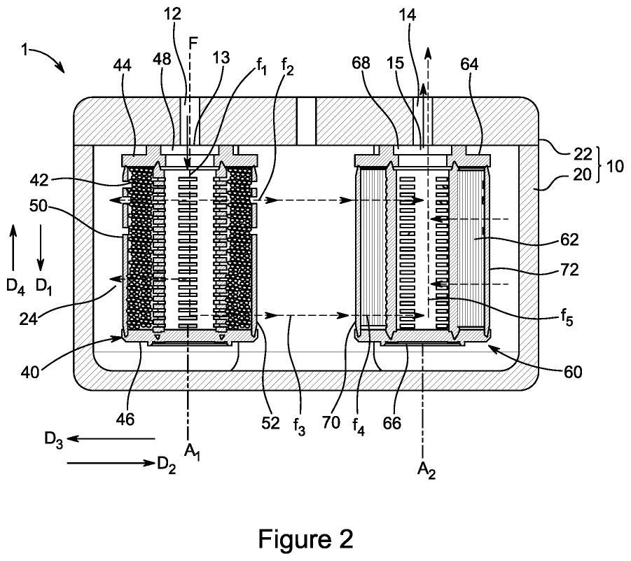

FIG. 1 shows a side perspective view of an embodiment of a filter unit 1. The filter unit 1 is configured to filter a fluid. The fluid is filtered as it passes through the filter unit 1. The flow into and out of the filter unit 1 is indicated in dashed arrows in FIG. 1. The filter unit 1 includes a housing 10 containing filters 40, 60 (shown in FIG. 2) which may be laterally arranged with respect to each other. The filter unit 1 is a removable filter unit 1 that is configured to be removed and replaced after removing a particular amount of containment(s). In an embodiment, the filter unit 1 can be configured to be installed into a filter manifold (not shown). For example, the filter manifold can include an inlet tube/pipe (not shown) and an outlet tube/pipe (not shown) that connect to the filter unit 1 and supply fluid through the filter unit 1.

As shown in FIG. 1, the housing 10 includes an inlet 12 and an outlet 14. Liquid (to be filtered) enters the filter unit 10 through the inlet 12. The liquid is filtered within the housing 10 and the filtered liquid is then discharged from the filter unit 1 through the outlet 14. The filter unit 1 is configured to filter a liquid used in semiconductor manufacturing. For example, in some embodiments, the filter unit 1 is configured to filter liquids used in photolithography and/or wet etch and clean. The liquid filtered by the filter unit 1 may include one or more acids, bases, oxidizers, and/or reducers or any combinations thereof. For example, the liquid may be water (e.g., deionized water), HCl, HNO₃, isopropyl alcohol, or the like. The housing 10 can also include a vent 16 for allowing discharge of gas from the filter unit 1. For example, the vent 16 is configured to allow gas that enters with the liquid (e.g., bubbles, etc.) to be vented from the housing 10.

In the illustrated embodiment, the housing 10 includes a base 20 and a cover 22 that is affixed to the base 20. The housing 10 may be assembled mechanically and/or via bonding (e.g., thermal bonding, adhesive bonding, etc.). As shown in the illustrated embodiment, the housing 10 can be assembled via bonding (e.g., the cover 22 thermal bonded to the base 20). For example, the cover 20 may be bonded (e.g., thermally bonded, adhesive bonded, etc.) to the base 20. In an embodiment, the housing 10 may be mechanically assembled (e.g., the cover 22 mechanically attached to the base 20). For example, the cover 22 and the base 20 may be mechanically affixed together configured via a snap fit, via lock and key mechanism, or the like. In such embodiments, the housing 10 may include seal(s) (not shown) to provide sealing between the cover 22 and the base 20. As shown in FIG. 1, the inlet 12 and outlet 14 can be formed in the cover 22. The inlet 12 and the outlet 14 are provided in the same side of the housing 10 (e.g., in the upper side 23 of the housing 10). In an embodiment, the housing 10 may also include a drain (not shown) that allows for draining the housing 10 of liquid prior to the filter unit 1 being disconnected. For example, the drain can be provided in the base 20 of the housing 10 (e.g., the bottom side of the housing 10). It should be appreciated that the housing 10 in an embodiment may have the inlet 12 and the outlet 14 formed in different sides of the housing 10. In other embodiments, the housing 10 may be formed to have a different shape and/or of different parts than a base 20 and a cover 22 as shown in FIG. 1.

FIG. 2 is a cross-sectional view of the filter unit 1. For example, the cross-section of the view in FIG. 2 is along the line II-II in FIG. 1. As shown in FIG. 2, the filter unit 1 includes the housing 10, a first filter 40, and a second filter 60. The housing 10 has an enclosed internal volume 24. The filters 40, 60 are disposed in the housing 10. As shown in FIG. 2, the filters 40, 60 are disposed within the internal volume 24 of the housing 10. The filter unit 1 has a liquid flow path F through which the liquid flows through the filter unit 1. The liquid flow path F extends from the inlet 12 to the outlet 14 through the first filter 40 and the second filter media 60 in series. The liquid is filtered by the filters 40, 60 as it passes through the liquid flow path F.

The first filter 40 includes a first filter media 42, a first axial end 44, a second axial end 46, and an axial inlet 48. The first axial end 44 and the second axial end 46 are opposite ends of the first filter 40 along the axis A₁ of the first filter 40. For example, the axis A₁ is the axis that extends along the height of the tubular shape of the first filter 40. The axial inlet 48 is formed in the first axial end 44 of the first filter 40. The first filter media 42 extends along an axial direction of the filter 40 (e.g., axial direction D₁, axial direction D₄) between the first axial end 44 and the second axial end 46 of the first filter 40. The first filter media 42 can have a tubular shape within the first filter 40. The first filter media 42 forms a radial outlet of the first filter 40. For example, liquid enters the first filter 40 through its axial inlet 48 and is discharged from the first filter 40 (after being filtered) from its first filter media 42.

The first axial end 44 of the first filter 40 is affixed to an inner surface 26 of the housing 10. The first axial end 44 of the first filter 40 can be bonded or mechanically affixed to the inner surface 26 of the housing 10. In the illustrated embodiment, the first axial end 44 is bonded (e.g., thermally bonded, adhesive bonded, etc.) to the housing 10. In an embodiment, the first axial end 44 may be mechanically affixed to the housing 10 via a snap fit, threads (e.g., the first axial end 44 having threads that screw into the inner surface 26 of the housing 10), or the like. The first axial end 44 of the first filter 40 is disposed over the opening 13 in the housing 10 for the inlet 12. The liquid flows from the opening 13 of the inlet 12 into the first filter 40. The first axial end 44 of the first filter 40 entirely covers the opening 13 for the inlet 12 such as the liquid flowing from the inlet 12 into the housing 10 is forced to flow into the first filter 20. The liquid then flows through the filter media 42 and is discharged from the first filter 40 into the internal volume 24 of the housing 10. The liquid enters the first filter 40 through the axial inlet 48 in an axial direction D₁ and is radially discharged from the first filter 40 (e.g., in direction D₂ from axis A₁, in direction D₃ from axis A₁, in a direction into the page in FIG. 2, in a direction out of the page in FIG. 2, etc.). Within the internal volume 24 of the housing 10, the liquid then flows from the filter media 42 of the first filter 40 to the filter media 62 of the second filter 40. As shown in FIG. 2, the second axial end 46 of the first filter 40 may be configured to be spaced apart from the housing 10 (e.g., from the bottom side of the housing 10).

The second filter 60 includes a filter media 62, a first axial end 64, a second axial end 66, and an axial outlet 68. The first axial end 64 and the second axial end 66 are opposite ends of the second filter 60 along the axis A₂ of the second filter 60. For example, the axis A₂ is the axis that extends along the length of the tubular shape of the second filter 60. The axial outlet 68 is formed in the first axial end 64 of the second filter 60. The second filter media 62 extends along an axial direction of the filter 60 (e.g., axial direction D₁, axial direction D₄) between the first axial end 64 and the second axial end 66 of the second filter 60. The second filter media 62 can have a tubular shape within the first filter 60. The second filter media 62 forms a radial inlet of the second filter 60. For example, liquid radially enters the second filter 60 through its second filter media 62 and is axially discharged from the second filter 60 (after being filtered) from its axial outlet 68.

The first axial end 64 of the second filter 60 is affixed to an inner surface 26 of the housing 10. The first axial end 44 of the second filter 60 can be bonded or mechanically affixed to the inner surface 26 of the housing 10. In the illustrate embodiment, the first axial end 64 is bonded (e.g., thermally bonded, adhesive bonded, etc.) to the housing 10. In an embodiment, the first axial end 64 may be mechanically affixed to the housing 10 via a snap fit, threads (e.g., first axial end 64 screwing into threads in the inner surface 26), or the like. The first axial end 64 of the second filter 60 is disposed over the opening 15 in the housing 10 for the outlet 16. The first axial end 64 of the second filter 60 entirely covers the opening 16 in the housing 10 for the outlet 16. The first axial end 64 forms a sealed connection with the inner surface 26 of the housing 10 such that the fluid in the open interior volume 24 is forced to flow through the second filter 60 to exit the housing 10 and the filter unit 1.

As shown in FIG. 2, the first axial end 44 of the first filter 40 and the first axial end 64 of the second filter 60 can be affixed to the same side of the housing 10. For example, the first axial ends 44, 64 of the filters 40, 60 are each bonded to the top side of the housing 10 (e.g., to the cover 22) in FIG. 2. In an embodiment, the openings 13, 15 in the inner surface 26 of the housing 10 for the inlet 12 and the outlet 14 may be located in different sides of the housing 10 (e.g., top side, bottom side, in a sidewall, etc.). In such an embodiment, the first axial ends 44, 64 of the filters 40, 60 may be bonded to said different sides of the housing 10.

The first axial end 64 of the second filter 60 is disposed over the opening 15 in the housing 10 for the inlet 14. The liquid that flows into the second filter 60 is discharged from the second filter 60 through its axial outlet 68 into the outlet 14 in the housing 10. The liquid flows from the axial outlet 68 of the second filter 60 into outlet 14 of the housing 10. The liquid then flowing out of the filter unit 1 from the outlet 14 of the housing 10. The filter media 62 forms a radial inlet of the second filter 60. The liquid (discharged from the first filter 40 flowing through internal volume 24) radially enters the second filter 60 through filter media 62 (e.g., in direction D₂ towards axis A₂, in direction D₃ towards axis A₂, in a direction into the page in FIG. 2, in a direction out of the page in FIG. 2, etc.) and is axially discharged from the second filter 60 (e.g., in direction D₄). As shown in FIG. 2, the second axial end 66 of the second filter 60 may be configured to be spaced apart from the housing 10 (e.g., from the bottom side of the housing 10).

The liquid flow path F extends through the housing 10 from the inlet 12 to the outlet 14. The liquid flow path is configured to extend through the filters 40, 60 in series. The liquid flow path F extends from the inlet 12 to the outlet 14 through the first filter media 42 of the first filter 40 and the second filter 60 in series. The liquid first being filtered by the first filter media 42 and then filtered by the second filter media 62 (e.g., the liquid filtered by the first filter media 42 is filtered further by the second filter media 62). The liquid flow path F is formed of a plurality of portions ƒ₁, ƒ₂ ƒ₃, ƒ₄, fs. In an embodiment, the portions ƒ₁, ƒ₂ ƒ₃, ƒ₄, ƒ₅ of the flow path are connected to each other consecutively. For example, second portion ƒ₂ connects the first portion ƒ₁ to the third portion ƒ₃ (e.g., the second portion ƒ₂ extending from an end of the first portion f₁ to a beginning of the third portion ƒ₃).

A first portion ƒ₁ of the liquid flow path F extends through the first filter 40 along the axis A₁ of the first filter 40. For example, the first portion ƒ₁ extends from the inlet 12 of the housing 10 through the axial inlet 48 into first filter 40. A first portion ƒ₁ of the liquid flow path F directs the liquid (to be filtered) from the inlet 12 of the housing 10 into the first filter 40. The second portion ƒ₂ of the liquid flow path F extends radially outward through the first filter media 42. For example, the second portion ƒ₂ extends out of the first filter 24 through the first filter media 42 into the internal volume 24 of the housing 10. The second portion ƒ₂ is configured to direct to flow radially outward (e.g., in direction D₂ from axis A₁, in direction D₃ from axis A₁, in the direction into the page from axis A₁, in the direction out of the page from axis A₁, etc.) from the first filter media 42 of the first filter 40. The liquid is filtered as it passes through the first filter media 42. For example, in the illustrated embodiment, the liquid is filtered as it passes through the resin beads of the first filter media 42. The liquid filtered by the first filter media 42 is discharged radially from the first filter into the internal volume 24 of the housing 10.

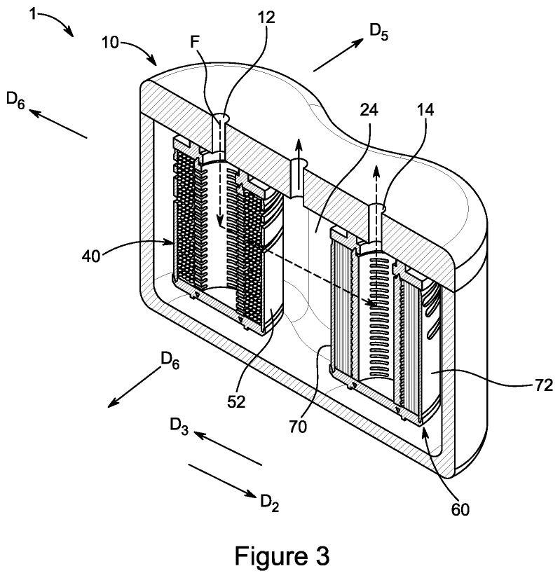

A third portion ƒ₃ of the liquid flow path F extends from the first filter media 42 of the first filter 40 to the second filter media 62 of the second filter 60. As shown in FIG. 3, the third portion ƒ₃ extends through the open portion internal volume 24 of the housing 10 from the first filter 40 to the second filter 60. For example, as shown in FIG. 2, third portion ƒ₃ can extend through the internal volume 24 external to both the first filter 40 and the second filter 60. As shown in FIG. 2, the third portion ƒ₃ can extend in the same direction (e.g., direction D₂) as the second portion ƒ₂.

A fourth portion ƒ₄ of the liquid flow path F extends radially inward through the second filter media 62. The fourth portion ƒ₄ extends from outside the second filter 60 (e.g., from the internal volume 24) into the second filter 60. The fourth portion ƒ₄ extends radially inward into the second filter 60 (e.g., in direction D₂ towards the axis A₂, in direction D₂ towards the axis A₂, in the direction into the page from axis A₂, in the direction out of the page from axis A₂, etc.). As shown in FIG. 2, the second portion ƒ₂, the third portion ƒ₃, the fourth portion ƒ₄ may all extend in the same direction D₂.

A fifth portion ƒ₅ of the liquid flow path F extends through the second filter 60 along the axis A₂ of the second filter 60. For example, the fifth portion ƒ₅ extends from within the second filter 60 through the axial outlet 68 to the outlet 14 of the housing 10. The fifth portion ƒ₅ of the liquid flow path F directs the filtered liquid from the second filter 60 to the outlet 14 of the housing 10. The fifth portion ƒ₅ extends axially through the second filter 60 (e.g., direction D₄). For example, the fifth portion ƒ₅ can extend in an opposite axial direction D₄ to the first portion ƒ₁. The fifth portion ƒ₅ is configured to direct the liquid (after being filtered by the second filtering media 42) from the second filter 60 to the outlet 14 of the housing. The filtered liquid is then discharged from the filter unit 1 from the outlet 14 of the housing 10. The liquid (to be filtered) enters the filter unit 1 through the inlet 12, is passed through the filters 40, 42, and their filter medias 42, 62 in series, and the filtered liquid is then discharged from the outlet 14.

The filters 40, 60 of the filter unit 1 may be configured to filter contaminants that include, for example, solid particulates, liquid impurities (e.g., organics, etc.), and/or dissolved chemical species (e.g., dissolved metals, ions, etc.). The filter media 42, 62 used in the filter unit 1 can be selected such that the filter unit 1 removes the desired contaminant(s) form the liquid.

As shown in FIG. 2, the first filter media 42 and the second filter media 62 are different types of filter media. In such an embodiment, the first filter media 42 provides a first type of contaminant filtering and the second filter media 62 provides a second type of contaminant filtering. For example, the first filter media 42 may provide metal ion filtering and the second filter media 62 may provide particle filtering. In an embodiment, the first filter media 42 may generate particles (e.g., resin beads, etc.) during use, and the second filter media 62 may provide particle filtering that captures the particles generated by the first filter media 42. This can advantageously allow for a single filter unit to provide multiple types of contaminant filtering in a single unit and/or to employ types of filter media that generate particles.

In an embodiment, the first filter media 42 and the second filter media 62 may be the same type of filter media. In such an embodiment, the first filter media 42 and the second filer media 62 provide the same type of contaminant filtering. The first filter media 42 can be configured to remove a contaminant to a first concentration in the liquid and the second filter media 62 can be configured to further remove the contaminant to a second lower concentration in the liquid. This can advantageously allow for the filter unit to provide high load filtration for liquids that contain high amounts of a contaminant.

In the illustrated embodiment, the first filter media 42 is resin beads. The resin beads are in the form of a packed bed. In an embodiment, the resin beads can be one type (single component) or multiple types (multi-component). In the illustrated embodiment, the second filter media 62 is a membrane. A membrane filter in an embodiment can have single layer or multiple layers (e.g., a fabric layer, a polymer coating layer, etc.). In an embodiment, the first filter media 42 and the second filter media 62 may each be selected from one of a membrane, resin beads, hollow fibers, depth fibers, a sponge based media, or a combination thereof. For example, a membrane can be configured to filter organics, metals, particles, ions (e.g., cations and anions), etc. from liquid. For example, resin beads can be configured to filter metals organics (e.g., resin beads in the form of an activated carbon bed, etc.). For example, depth fibers are generally configured for use in high contaminant load applications.

FIG. 3 is a perspective cross-sectional view of the filter unit 1. FIG. 3 is a perspective view of the cross-section in FIG. 2. The filters 40, 60 are each hollow. The filters 40, 60 each have a tubular shape. The tubular shape is capped at the second axial end 46, 66. As shown in FIG. 3, the tubular shape of each filter 40, 60 is a cylinder shape. It should be appreciated that the filters 40, 60 may have a different tubular shape in other embodiments. For example, one or both of the filters 40, 60 may have a square tubular shape, an oval tubular shape, a triangular tubular shape, a non-polygonal tubular shape, etc. in other embodiments. In such embodiments, the filters 40, 60 may have the same or different shapes. The liquid is radially discharged from the first filter media 42 of the first filter 40. For example, the liquid can be discharged in radial directions D₂, D₃, D₅, D₆ from the first filter 40.

As shown in FIGS. 2 and 3, the filters 40, 60 are spaced apart from each other within the internal volume 24 of the housing 10. The first filter 40 includes one or more sides 50, 52 that extend between its axial ends 44, 46. The second filter includes one or more sides 70, 72 that extend between its axial ends 44, 46. As shown in FIGS. 2 and 3, the filters 40, 60 can be side by side by side within the housing 10. In an embodiment, the side(s) of each filter 40, 60 may be formed by a single circumferential surface of the filter 40, 60, as shown in FIG. 3. The sides 50, 52, 70, 72 of the filters 40, 46 are each spaced apart from the housing 10 within the housing 10. Each of the filters 40, 46 can be configured to only be in contact with the housing 10 through their axial ends 44, 46, 64, 66. As shown in FIGS. 2 and 3, each of the filters 40, 60 can be configured to only have its first axial end 44 contacting the housing 10. For example, the first filter 40 can have a first side 50 and a second side 52 that are opposite sides of the first filter 40, and the second filter 60 can have a first side 70 and a second side 72 that are opposite sides of the second filter 60. The second side 52 of the first filter 40 and the first side 70 of the second filter 60 face each other. The first side 50 of the first filter 40 and the second side 72 face opposite directions and towards opposite sidewalls of the housing 10.

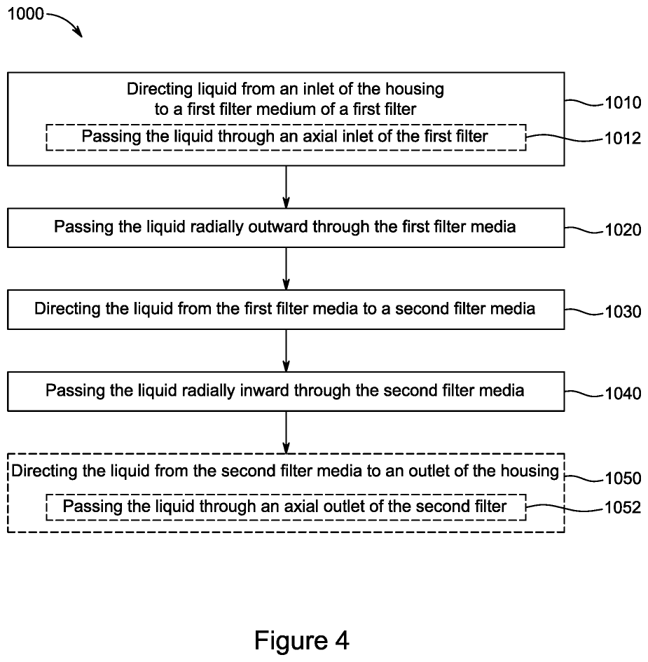

FIG. 4 is a flow diagram of a method 1000 of filtering a liquid in a filter unit. The method 1000 may be applied to the filter unit 1 of FIGS. 1-3. The method 1000 starts at 1010.

At 1010, the liquid is directed from an inlet (e.g., inlet 12) of a housing (e.g., housing 10) to a first filter media of a first filter (e.g., first filter media 42 of first filter 40). In an embodiment, directing the liquid at 1010 includes passing the liquid through an axial inlet of the first filter 1012 (e.g., axial inlet 48). The method 1000 then proceeds to 1020.

At 1020, the liquid is passed radially outward through the filter media. For example, the liquid is directed out of the second filter into open space of the internal volume of the housing (e.g., open space of the internal volume 24) that is between the housing and the filters. The method then proceeds to 1030.

At 1030, the liquid is directed from the first filter media to a second filter media of a second filter (e.g., second filter media 62 of second filter 60). At 1030, the liquid is being directed through the open space of internal volume of the housing between the filters. The method 1000 then proceeds to 1040.

At 1040, the liquid is passed radially inward through the second filter media. For example, the liquid is directed to flow into the second filter by flowing through the second filter media. In an embodiment, the method 1000 may then also then proceed to 1050.

At 1050, the liquid is directed from the second filter media to an outlet of the housing (e.g., outlet 14). In an embodiment, directing the liquid to the outlet of the housing at 1050 can include passing the liquid through an axial outlet of the second filter 1052 (e.g., axial outlet 68). For example, directing the liquid at 1050 includes directing the liquid from the axial outlet of the second filter into an opening in the housing for the outlet (e.g., opening 15).

It should be appreciated that the method 1000 in an embodiment may be modified to include features as described above with respect to the filter unit 1 in FIGS. 1-3.

Aspects:

Any of Aspects 1-10 can be combined with any of aspects 11-16.

Aspect 1. A filter unit for filtering liquid, comprising: a housing having an inlet and an outlet; a first filter disposed in the housing and including: a first axial end affixed to an inner surface of the housing, an axial inlet disposed over an opening of the inlet of the housing, and a first filter media; a second filter disposed in the housing and including: a first axial end affixed to the inner surface of the housing, an axial outlet disposed over an opening of the outlet in the housing, and a second filter media; and a liquid flow path extending from the inlet to the outlet through the first filter media and the second filter media in series, the liquid flow path configured to direct the liquid radially outward through the first filter media and to direct the liquid radially inward through the second filter media.

Aspect 2. The filter unit of Aspect 1, wherein the axial inlet of the first filter is formed in the first axial end of the first filter, and the axial outlet of the second filter is formed in the first axial end of the second filter.

Aspect 3. The filter unit of any one of Aspects 1 and 2, wherein the first filter media is configured to be a radial outlet of the first filter, and the second filter media is configured to be a radial inlet of the second filter.

Aspect 4. The filter unit of any one of Aspects 1-3, wherein the first filter is spaced apart from the second filter within the housing.

Aspect 5. The filter unit of any one of Aspects 1-4, wherein the first filter and the second filter are disposed side by side within the housing.

Aspect 6. The filter unit of any one of Aspects 1-5, wherein the liquid flow path includes, in order: a first portion extending through the first filter along an axis of the first filter, a second portion extending radially outward through the first filter media, a third portion extending from the first filter media to the second filter media, a fourth portion extending radially inward through the second filter media, a fifth portion extending through the second filter along an axis of the second filter.

Aspect 7. The filter unit of Aspect 6, wherein the third portion extends in a first direction that is radially outward with respect to the first filter and radially inward with respect to the second filter.

Aspect 8. The filter unit of any one of Aspects 1-7, wherein the first filter media and the second filter media are each selected from a membrane, resin beads, hollow fibers, depth fibers, a sponge based media, or a combination thereof.

Aspect 9. The filter unit of any one of Aspects 1-8, wherein the first filter media and the second filter media are the same type of filter media.

Aspect 10. The filter unit of any one of Aspects 1-8, wherein the first filter media and the second filter media are different types of filter media.

Aspect 11. A method of filtering a liquid within a filter unit, the filter unit including a housing with an inlet and an outlet, the method comprising: directing the liquid from the inlet of the housing to a filter media of a first filter disposed in the housing, the first filter including a first axial end affixed to an inner surface of the housing and an axial inlet disposed over an opening of the inlet of the housing; passing the liquid radially outward through the first filter media; directing the liquid from the first filter media to a second filter media of a second filter disposed in the housing, the second filter including a first axial end affixed to the inner surface of the housing and an axial outlet disposed over an opening of the outlet in the housing; and passing the liquid radially inward through the second filter media.

Aspect 12. The method of Aspect 11, further comprising: directing the liquid from the second filter media to an outlet of the housing.

Aspect 13. The method of any one of Aspects 11 and 12, wherein the directing of the liquid from the second filter media to an outlet of the housing includes passing the liquid through an axial outlet of the second filter.

Aspect 14. The method of any one of Aspects 11-13, wherein the directing of the liquid from the first filter media to the second filter media of the second filter includes directing the liquid.

Aspect 15. The method of any one of Aspects 11-14, wherein directing the liquid from an inlet of the housing to the filter media of the first filter includes passing the liquid through an axial inlet of the first filter.

Aspect 16. The method of any one of Aspects 11-15, wherein the first filter media and the second filter media are selected from one of a membrane, resin beads, hollow fibers, depth fibers, a sponge based media, or a combination thereof.

The examples disclosed in this application are to be considered in all respects as illustrative and not limitative. The scope of the invention is indicated by the appended claims rather than by the foregoing description; and all changes which come within the meaning and range of equivalency of the claims are intended to be embraced therein.

What is claimed is:

1. A filter unit for filtering liquid, comprising:
a housing having an inlet and an outlet;
a first filter disposed in the housing and including: a first axial end affixed to an inner surface of the housing, an axial inlet disposed over an opening of the inlet of the housing, and a first filter media;
a second filter disposed in the housing and including: a first axial end affixed to the inner surface of the housing, an axial outlet disposed over an opening of the outlet in the housing, and a second filter media; and
a liquid flow path extending from the inlet to the outlet through the first filter media and the second filter media in series, the liquid flow path configured to direct the liquid radially outward through the first filter media and to direct the liquid radially inward through the second filter media.

2. The filter unit of claim 1, wherein
the axial inlet of the first filter is formed in the first axial end of the first filter, and
the axial outlet of the second filter is formed in the first axial end of the second filter.

3. The filter unit of claim 1, wherein
the first filter media is configured to be a radial outlet of the first filter, and
the second filter media is configured to be a radial inlet of the second filter.

4. The filter unit of claim 1, wherein the first filter is spaced apart from the second filter within the housing.

5. The filter unit of claim 1, wherein the first filter and the second filter are disposed side by side within the housing.

6. The filter unit of claim 1, wherein the liquid flow path includes, in order:
a first portion extending through the first filter along an axis of the first filter,
a second portion extending radially outward through the first filter media,
a third portion extending from the first filter media to the second filter media,
a fourth portion extending radially inward through the second filter media,
a fifth portion extending through the second filter along an axis of the second filter.

7. The filter unit of claim 6, wherein the third portion extends in a first direction that is radially outward with respect to the first filter and radially inward with respect to the second filter.

8. The filter unit of claim 1, wherein the first filter media and the second filter media are each selected from a membrane, resin beads, hollow fibers, depth fibers, a sponge based media, or a combination thereof.

9. The filter unit of claim 1, wherein the first filter media and the second filter media are the same type of filter media.

10. The filter unit of claim 1, wherein the first filter media and the second filter media are different types of filter media.

11. A method of filtering a liquid within a filter unit, the filter unit including a housing with an inlet and an outlet, the method comprising:
directing the liquid from the inlet of the housing to a filter media of a first filter disposed in the housing, the first filter including a first axial end affixed to an inner surface of the housing and an axial inlet disposed over an opening of the inlet of the housing;
passing the liquid radially outward through the first filter media;
directing the liquid from the first filter media to a second filter media of a second filter disposed in the housing, the second filter including a first axial end affixed to the inner surface of the housing and an axial outlet disposed over an opening of the outlet in the housing; and
passing the liquid radially inward through the second filter media.

12. The method of claim 11, further comprising:
directing the liquid from the second filter media to an outlet of the housing.

13. The method of claim 12, wherein the directing of the liquid from the second filter media to an outlet of the housing includes passing the liquid through an axial outlet of the second filter.

14. The method of claim 11, wherein the directing of the liquid from the first filter media to the second filter media of the second filter includes directing the liquid.

15. The method of claim 11, wherein directing the liquid from an inlet of the housing to the filter media of the first filter includes passing the liquid through an axial inlet of the first filter.

16. The method of claim 11, wherein the first filter media and the second filter media are selected from one of a membrane, resin beads, hollow fibers, depth fibers, a sponge based media, or a combination thereof.
